(19) United States
(12) Patent Application Publication
(10) Pub. No.: US 2026/0257361 A1
(43) Pub. Date: Sep. 3, 2026

(54) BRAKE DIAGNOSIS METHOD, BRAKE DIAGNOSIS DEVICE, STORAGE MEDIUM STORING BRAKE DIAGNOSIS PROGRAM, AND CONTROL DEVICE FOR ROBOT

(71) Applicant: FANUC CORPORATION, Minamitsuru-gun, Yamanashi (JP)

(72) Inventor: Kazuki ISHIMOTO, Yamanashi (JP)

(73) Assignee: FANUC CORPORATION, Minamitsuru-gun, Yamanashi (JP)

(21) Appl. No.: 18/881,817

(22) PCT Filed: Nov. 14, 2022
(86) PCT No.: PCT/JP2022/042216

§ 371 Date: Jan. 7, 2025

(51) Int. Cl. B25J 9/16; B25J 19/00

(52) U.S. Cl. CPC B25J 9/1674; B25J 19/0004

(57) ABSTRACT

In order to precisely measure a gravitational torque and precisely diagnose a brake, a brake diagnosis method for a robot includes: acquiring, in a state in which a brake of a motor that drives a second member with respect to a first member is released, a movement-time torque generated by the motor during a movement of the second member with respect to the first member by the operation of the motor; calculating a brake diagnosis torque on the basis of the acquired movement-time torque; and using the calculated brake diagnosis torque to determine presence or absence of an abnormality of the brake.

### TECHNICAL FIELD

The present disclosure relates to a brake diagnosis method, a brake diagnosis device, a brake diagnosis program, and a control device for a robot.

### BACKGROUND

In a known method in the related art, in order to diagnose a decrease in the holding torque of a brake provided in a motor of a robot, a motor torque is applied with the brake applied, and it is determined whether or not the motor slips (for example, see Japanese Unexamined Patent Application, Publication No. 2005-254410). When the brake to be diagnosed is provided in a motor that drives a member subjected to gravity, it is necessary to take into account the gravity torque in addition to the brake holding torque, as the motor torque applied at the time of diagnosis. The gravity torque acting on the motor is obtained from the actually measured value of the motor torque required to stop the member subjected to gravity, in a state in which the brake is released.

### SUMMARY

One aspect of the disclosure is a brake diagnosis method for a robot, including: acquiring, in a state in which a brake of a motor that drives a second member with respect to a first member is released, an in-motion torque generated by the motor while the second member is moved with respect to the first member by operation of the motor; calculating a brake diagnosis torque on a basis of the acquired in-motion torque; and determining whether or not the brake is abnormal by using the calculated brake diagnosis torque.

### BRIEF DESCRIPTION OF DRAWINGS

FIG. 1 is a perspective view showing an example of a robot and a control device to which a brake diagnosis method according to a first embodiment of the present disclosure is applied.

FIG. 2 is a block diagram showing a brake diagnosis device for executing the brake diagnosis method in FIG. 1.

FIG. 3 is a flowchart showing the brake diagnosis method in FIG. 1.

FIG. 4 is a flowchart for explaining a gravity torque measurement step in FIG. 3.

FIG. 5 includes graphs for explaining temporal changes of a speed command to a target motor and the torque in the gravity torque measurement step in FIG. 3.

FIG. 6 is a flowchart for explaining an abnormality determination step in FIG. 3.

FIG. 7 is a flowchart for explaining an abnormality determination step in a brake diagnosis method according to a second embodiment of the present disclosure.

### DETAILED DESCRIPTION OF EMBODIMENTS

A brake diagnosis method and a brake diagnosis device 10 for a robot 1 according to a first embodiment of the present disclosure will be described below with reference to the drawings.

The brake diagnosis method for the robot 1 according to this embodiment is, for example, a method for diagnosing brakes 9 provided in six motors 8 in a vertical six-axis articulated robot.

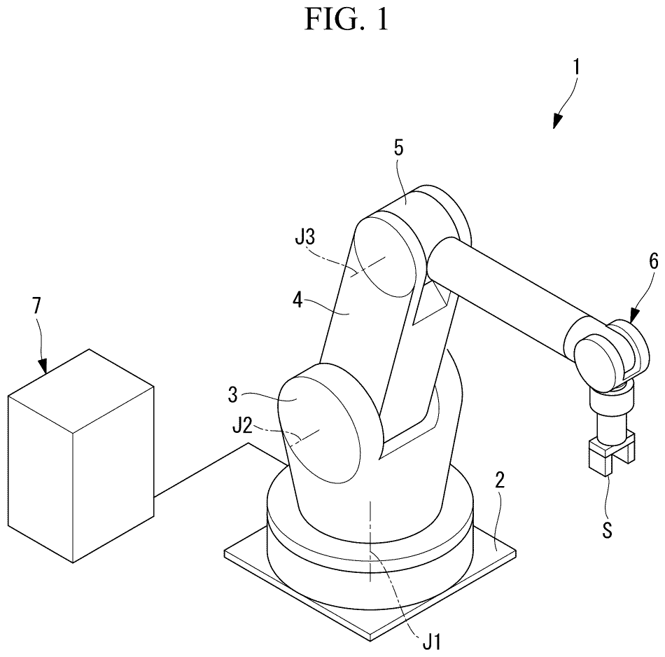

As shown in FIG. 1, the robot 1 includes a base 2 fixed to an installation surface such as a floor, and a revolving drum 3 supported rotatably about a vertical first axis J1 with respect to the base 2. The robot 1 includes a first arm 4 supported rotatably about a horizontal second axis J2 with respect to the revolving drum 3.

The robot 1 further includes a second arm 5 supported rotatably about a third axis J3, parallel to the second axis J2, with respect to the first arm 4, and a three-axis wrist unit 6 attached to the distal end of the second arm 5. A tool S, such as a hand, or a workpiece is fixed to the tip of the wrist unit 6. In FIG. 1, reference numeral 7 denotes a control device.

Here, for example, a case of diagnosing a brake 9 of a motor (hereinbelow, a target motor) 8 that rotationally drives the first arm (second member) 4 about the second axis J2 with respect to the revolving drum (first member) 3 will be described as an example.

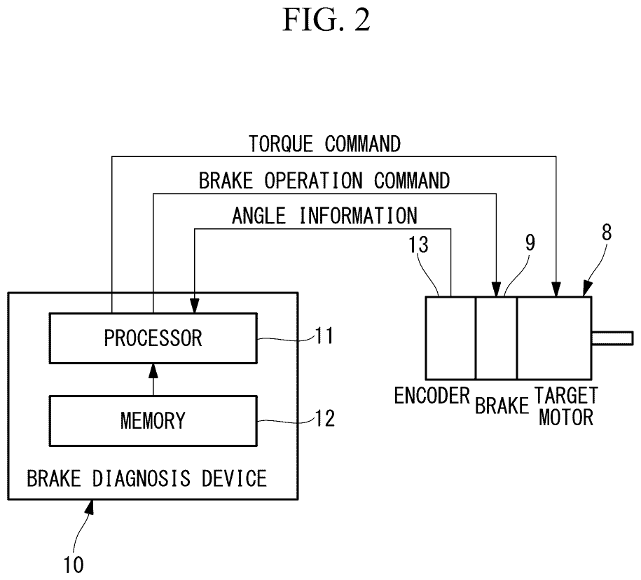

As shown in FIG. 2, the brake diagnosis device 10 according to this embodiment includes at least one processor 11 and a memory 12. The processor 11 acquires angle information from an encoder 13 provided in the target motor 8. The processor 11 outputs, to the brake 9 provided in the target motor 8, a brake operation command for actuating the brake 9 or releasing the brake 9. The processor 11 also outputs, to the target motor 8, a torque command for rotationally driving the target motor 8.

The brake diagnosis method according to this embodiment is performed while the robot 1 takes an arbitrary posture. For example, the diagnosis of the brake 9 of the target motor 8 that rotationally drives the first arm 4 is performed in a state in which the first arm 4 is disposed at an arbitrary first position with respect to the revolving drum 3.

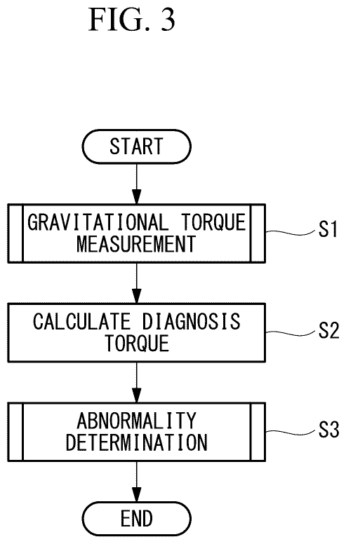

As shown in FIG. 3, the brake diagnosis method according to this embodiment includes a gravity torque measurement step S1, a diagnosis torque calculation step S2, and an abnormality determination step S3.

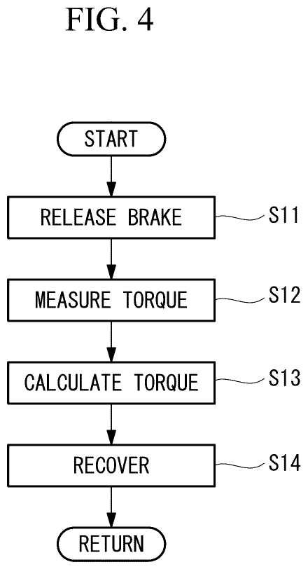

As shown in FIG. 4, the gravity torque measurement step S1 includes a brake release step S11, a torque measurement step S12, a torque calculation step S13, and a recovery step S14.

In the brake release step S11, the processor 11 sends a brake operation command only to the target motor 8 to release the brake 9 of the target motor 8.

In the torque measurement step S12, the processor 11 measures the torque (in-motion torque) while operating the target motor 8 in one direction from a first position to a second position. The first position, the second position, and positions during operation are calculated by the processor 11 on the basis of the angle information sent from the encoder 13 provided in the target motor 8.

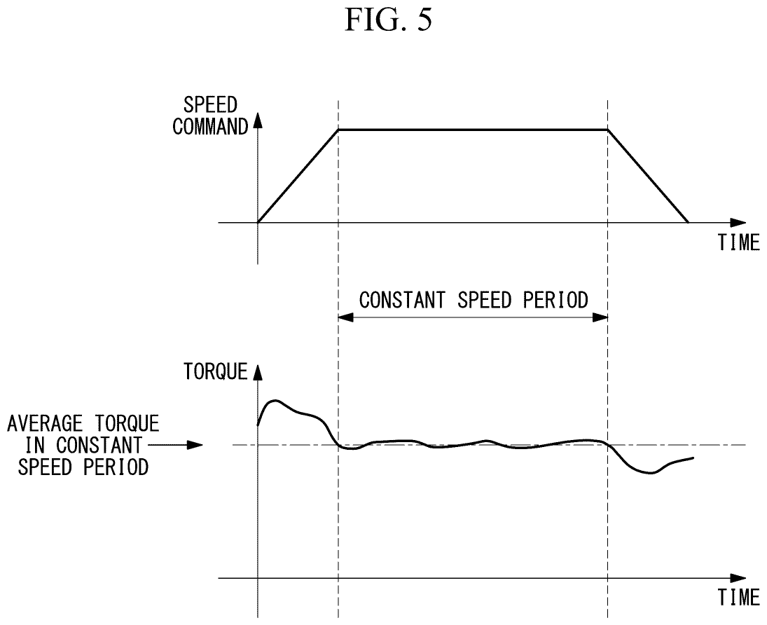

FIG. 5 shows temporal changes of the speed command to the target motor 8 and the torque command (current value) output to the target motor 8 on the basis of the speed command in the torque measurement step S12. When the torque measurement step S12 starts, the target motor 8 accelerates, then operates at a constant speed, and then decelerates to reach the second position.

In the torque calculation step S13, the processor 11 calculates the in-motion torque by time-averaging the torque command to the target motor 8 measured during a constant speed period in which the target motor 8 operates at the constant speed. The in-motion torque includes an anti-gravity torque required for the target motor 8 to oppose gravity and an anti-kinetic friction torque required for the target motor 8 to oppose kinetic friction.

As shown in FIG. 5, because the torque command fluctuates at a high frequency, the torque command smoothed by passing through a low-pass filter may be time-averaged.

The amount of displacement of the target motor 8 from the first position to the second position can be sufficiently reduced by sufficiently reducing the speed in the constant speed period.

In the recovery step S14, the processor 11 supplies a torque command to the target motor 8 to operate the target motor 8 in the direction opposite to the direction in the operation in the torque measurement step S12, so that the target motor 8 returns to the first position. In the recovery step S14, the processor 11 accelerates the target motor 8 from the second position in the direction opposite to the direction in the torque measurement step S12, then operates the target motor 8 at a constant speed, and then decelerates the target motor 8 to allow the target motor 8 to reach the first position.

In the diagnosis torque calculation step S2, the processor 11 calculates a brake diagnosis torque by, for example, adding the calculated in-motion torque and a preset brake holding torque. The brake holding torque is a torque that can be held by the brake 9 in a normal state, and is stored in the memory 12.

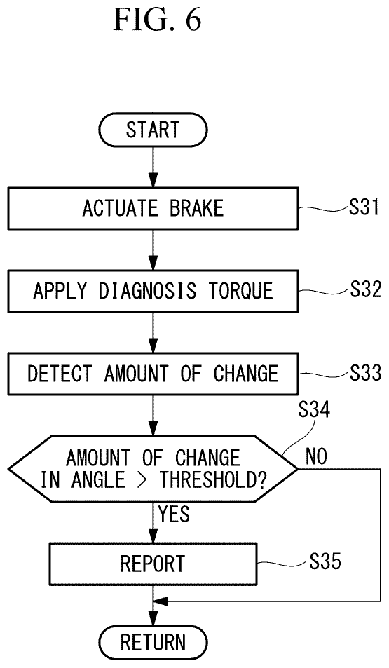

As shown in FIG. 6, the abnormality determination step S3 includes a brake actuation step S31, a diagnosis torque application step S32, and an amount of change detection step S33. The abnormality determination step S3 includes a comparison step S34 and a report step S35.

In the brake actuation step S31, the processor 11 outputs a brake operation command to operate only the brake 9 of the target motor 8.

In the diagnosis torque application step S32, the processor 11 causes the brake diagnosis torque calculated in the diagnosis torque calculation step S2 to be generated in the target motor 8 in a direction opposite to the gravity torque.

In the amount of change detection step S33, the amount of change in angle (amount of operation) of the target motor 8 from the time when the brake diagnosis torque is generated in the target motor 8 according to the torque command from the processor 11 is detected on the basis of the angle information sent from the encoder 13. In the comparison step S34, the processor 11 determines whether or not the amount of change in angle, detected in the amount of change detection step S33, is larger than a predetermined threshold stored in the memory 12.

In the report step S35, when the amount of change in angle is larger than the threshold as a result of the determination in the comparison step S34, the processor 11 outputs a brake abnormality alarm reporting that the brake 9 is abnormal. When the amount of change in angle is smaller than or equal to the threshold, the brake 9 is normal, and the process is terminated. The brake abnormality alarm may be any alarm that can be recognized by the five senses of an operator, such as a sound, a buzzer, lighting of a warning lamp, or vibration, in addition to displaying a message on a monitor (not shown).

The operation of the brake diagnosis method and the brake diagnosis device 10 according to this embodiment configured as described above will be described below.

According to this embodiment, because the in-motion torque is measured in a state in which the motor 8 is operated at a constant speed with the brake 9 released, there are advantages in that the influence of static friction is eliminated, and the gravity torque including kinetic friction can be measured accurately.

Because the accurately measured in-motion torque is used, there is an advantage in that whether or not the brake 9 is abnormal can be accurately diagnosed.

Furthermore, according to this embodiment, because the in-motion torque is measured prior to the diagnosis of the brake 9, there is an advantage in that the diagnosis of the brake 9 can be performed regardless of the posture of the robot 1. Furthermore, because the in-motion torque is measured prior to the diagnosis of the brake 9, there is an advantage in that the diagnosis of the brake 9 can be performed accurately even when the weight or the center of gravity of the tool S or the workpiece attached to the tip of the wrist unit 6 of the robot 1 is changed.

Although a method in which the diagnosis posture of the robot 1 having the brake 9 to be diagnosed and the gravity torque in that diagnosis posture are stored in advance may be considered, in that case, the robot 1 needs to take the diagnosis posture every time the brake 9 is diagnosed. Also, in that case, the gravity torque must be measured every time the weight or the position of the center of gravity of the tool S or the workpiece attached to the tip of the wrist unit 6 is changed, which is troublesome. According to this embodiment, the brake 9 can be easily diagnosed without these disadvantages.

In this embodiment, the case where the brake diagnosis device 10 operates the motor 8 and the brake 9 has been described as an example. In this case, the control device 7 that operates the robot 1 may include the brake diagnosis device 10. When the brake diagnosis device 10 is provided separately from the control device 7, the brake diagnosis device 10 acquires the torque command to the target motor 8 from the control device 7 in the gravity torque measurement step S1 and the abnormality determination step S3.

In this embodiment, the brake diagnosis device 10 diagnoses whether or not the brake 9 is abnormal by using the brake diagnosis torque. Alternatively, a brake diagnosis program may be executed to diagnose whether or not the brake 9 is abnormal. In that case, the brake diagnosis method described above may be executed by the brake diagnosis device 10 or the control device 7.

In this embodiment, the in-motion torque is calculated by detecting the torque generated by the target motor 8 during the constant speed operation of the target motor 8. However, the in-motion torque may be detected not only during the constant speed operation, but also during the acceleration operation. If the acceleration is known, the in-motion torque can be calculated accurately while eliminating the influence of static friction as in the case during the constant speed operation.

Furthermore, the in-motion torque is calculated on the basis of the torque measured in the constant speed period in the period in which the target motor 8 is moved from the first position to the second position. Instead, the in-motion torque may be calculated on the basis of the torque measured in the constant speed period in the period in which the target motor 8 returns from the second position to the first position. Alternatively, the in-motion torque may be calculated on the basis of the torques measured in both of outgoing and returning operations between the first position and the second position.

In the abnormality determination step S3, the brake diagnosis torque obtained by adding the in-motion torque and the brake holding torque is generated in the target motor 8 in the direction opposite to the gravity torque. Instead, the brake diagnosis torque calculated by subtracting the gravity torque from the brake holding torque may be generated in the target motor 8 in the same direction as the gravity torque.

In this embodiment, the case where the brake 9 of the motor (the target motor 8) that rotationally drives the first arm 4 with respect to the revolving drum 3 is diagnosed has been exemplified. Alternatively, the target motor 8 may be a motor that rotationally drives the second arm 5 with respect to the first arm 4 or a motor that rotationally drives each wrist element of the wrist unit 6.

Furthermore, in this embodiment, the motor subjected to the gravity torque has been described as the target motor 8. Instead, the brake diagnosis method according to this embodiment may be applied to a case where the brake 9 of a motor (the target motor 8) that is not subjected to gravity, such as a motor that rotationally drives the revolving drum 3 with respect to the base 2, is diagnosed.

In addition, in this embodiment, the case where the brake 9 of the vertical six-axis articulated robot is diagnosed has been exemplified. Instead, the present invention may be applied to a robot of any other form, such as a horizontal articulated robot. Furthermore, the brake diagnosis method according to this embodiment may be applied to diagnosis of the brake 9 of the motor 8 that drives a linear motion joint instead of the brake 9 of the motor 8 that drives a rotary joint.

Next, a brake diagnosis method and a brake diagnosis device 10 according to a second embodiment of the present disclosure will be described below with reference to the drawings.

This embodiment differs from the first embodiment in the abnormality determination step S3.

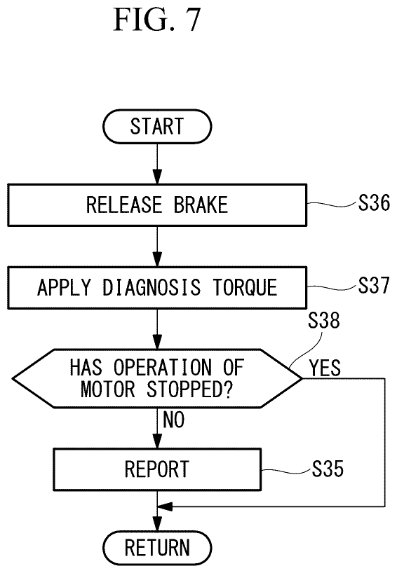

In this embodiment, as shown in FIG. 7, the abnormality determination step S3 includes a brake release step S36, a diagnosis torque application step S37, a determination step S38, and a report step S35. In the brake release step S36, the processor 11 outputs a brake release command to release only the brake 9 of the target motor 8. The target motor 8 whose brake 9 is released generates a torque opposing the gravity torque to maintain the target motor 8 in a stationary state.

In the diagnosis torque application step S37, the processor 11 causes the brake diagnosis torque calculated in the diagnosis torque calculation step S2 to be generated in the target motor 8 in the direction opposite to the gravity torque. At the same time or after the torque is generated, the processor 11 actuates the brake 9. As a result generating the brake diagnosis torque, the target motor 8 starts to be rotationally driven in the direction opposite to the gravity torque but is decelerated by actuating the brake 9.

In the determination step S38, the processor 11 determines whether or not the operation of the target motor 8 has stopped as a result of being decelerated by the actuation of the brake 9, that is, whether or not the rotational speed has become zero. If the rotational speed has become zero and the target motor 8 has stopped, the brake 9 is normal, and the process is terminated. If the rotational speed does not become zero and the target motor 8 does not stop, the process proceeds to the report step S35, and the abnormality of the brake 9 is reported.

According to this embodiment, there is an advantage in that the influence of static friction at the time of abnormality determination can be eliminated, compared with the case where the brake diagnosis torque is applied with the brake 9 actuated. Specifically, it is possible to prevent the target motor 8 from being kept in a stationary state by the static friction regardless of decreased brake holding torque, and thus to prevent an erroneous determination that the brake 9 is normal.

In this embodiment, in the determination step S38, the processor 11 determines whether or not the rotational speed has become zero as a result of deceleration by the actuation of the brake 9. Alternatively, as in the first embodiment, in the determination step S38, the processor 11 may determine whether or not the amount of displacement is smaller than a predetermined threshold.

Although the embodiments of the present disclosure have been described in detail above, the present disclosure is not limited to the above-described embodiments. Various additions, substitutions, changes, partial deletions, and the like can be made to these embodiments without departing from the spirit of the invention, or without departing from the spirit and scope of the invention derived from the contents described in the claims and equivalents thereof. For example, in the above-described embodiments, the order of operations and the order of processes are shown as examples and are not exhaustive.

### Feature 1

A brake diagnosis method for a robot, comprising:
acquiring, in a state in which a brake of a motor that drives a second member with respect to a first member is released, an in-motion torque generated by the motor while the second member is moved with respect to the first member by operation of the motor;
calculating a brake diagnosis torque on a basis of the acquired in-motion torque; and
determining whether or not the brake is abnormal by using the calculated brake diagnosis torque.

### Feature 2

The brake diagnosis method for a robot according to Feature 1, wherein whether or not the brake is abnormal is determined on a basis of an amount of operation of the motor after the brake diagnosis torque is generated in the motor with the brake applied.

### Feature 3

The brake diagnosis method for a robot according to Feature 1, wherein whether or not the brake is abnormal is determined on a basis of an amount of operation or a rotational speed of the motor after the brake diagnosis torque is generated in the motor while the second member is moved with respect to the first member.

### Feature 4

The brake diagnosis method for a robot according to Feature 2 or 3, wherein it is determined that the brake is abnormal in a case in which the amount of operation of the motor is larger than a predetermined threshold.

### Feature 5

The brake diagnosis method for a robot according to Feature 3, wherein it is determined that the brake is abnormal in a case in which the rotational speed of the motor does not become zero.

### Feature 6

The brake diagnosis method for a robot according to any one of Features 1 to 3, wherein the in-motion torque is a time-averaged value of a torque generated by the motor during a period in which the motor is operating at a constant speed.

### Feature 7

The brake diagnosis method for a robot according to any one of Features 1 to 4, wherein the brake diagnosis torque is a sum of the in-motion torque and a brake holding torque or a difference between the brake holding torque and the in-motion torque.

### Feature 8

The brake diagnosis method for a robot according to any one of Features 1 to 5, wherein, in a case in which it is determined that the brake is abnormal, the abnormality is reported.

### Feature 9

A brake diagnosis device for a robot, comprising at least one processor, wherein the processor is configured to execute the brake diagnosis method according to any one of Features 1 to 8.

### Feature 10

A brake diagnosis program for a robot, causing a computer to execute the brake diagnosis method according to any one of Features 1 to 8.

### Feature 11

A control device for a robot, comprising at least one processor configured to:
release a brake of a motor that drives a second member with respect to a first member;
allow the second member to move with respect to the first member by actuating the motor with the brake released;
acquire an in-motion torque generated by the motor while the second member is moved with respect to the first member;
calculate a brake diagnosis torque on a basis of the acquired in-motion torque; and
determine whether or not the brake is abnormal using the calculated brake diagnosis torque.

1. A brake diagnosis method for a robot, comprising:
acquiring, in a state in which a brake of a motor that drives a second member with respect to a first member is released, an in-motion torque generated by the motor while the second member is moved with respect to the first member by operation of the motor;
calculating a brake diagnosis torque on a basis of the acquired in-motion torque; and
determining whether or not the brake is abnormal by using the calculated brake diagnosis torque.

2. The brake diagnosis method for a robot according to claim 1, wherein the brake being abnormal is determined on a basis of an amount of operation of the motor after the brake diagnosis torque is generated in the motor with the brake applied.

3. The brake diagnosis method for a robot according to claim 1, wherein the brake being abnormal is determined on a basis of an amount of operation or a rotational speed of the motor after the brake diagnosis torque is generated in the motor while the second member is moved with respect to the first member.

4. The brake diagnosis method for a robot according to claim 2, wherein it is determined that the brake is abnormal when the amount of operation of the motor is larger than a predetermined threshold.

5. The brake diagnosis method for a robot according to claim 3, wherein it is determined that the brake is abnormal when the rotational speed of the motor does not become zero.

6. The brake diagnosis method for a robot according to claim 1, wherein the in-motion torque is a time-averaged value of a torque generated by the motor during a period in which the motor is operating at a constant speed.

7. The brake diagnosis method for a robot according to claim 1, wherein the brake diagnosis torque is a sum of the in-motion torque and a brake holding torque or a difference between the brake holding torque and the in-motion torque.

8. The brake diagnosis method for a robot according to claim 1, wherein, in a case in which it is determined that the brake is abnormal, the abnormality is reported.

9. A brake diagnosis device for a robot, comprising at least one processor, wherein the processor is configured to execute the brake diagnosis method according to claim 1.

10. A non-transitory computer readable storage medium storing a brake diagnosis program for a robot, causing a computer to execute the brake diagnosis method according to claim 1.

11. A control device for a robot, comprising at least one processor configured to:
release a brake of a motor that drives a second member with respect to a first member;
allow the second member to move with respect to the first member by actuating the motor with the brake released;
acquire an in-motion torque generated by the motor while the second member is moved with respect to the first member;
calculate a brake diagnosis torque on a basis of the acquired in-motion torque; and
determine whether or not the brake is abnormal using the calculated brake diagnosis torque.

12. The brake diagnosis method for a robot according to claim 3, wherein it is determined that the brake is abnormal when the amount of operation of the motor is larger than a predetermined threshold.
